(19) United States
(12) Patent Application Publication
(10) Pub. No.: US 2025/0314390 A1
(43) Pub. Date: Oct. 9, 2025

(54) BUILDING AUTOMATION SYSTEM WITH AUTOMATED SEQUENCING FOR MANAGERLESS TWINNING AND METHOD THEREOF

(71) Applicant: Tyco Fire & Security GmbH, Neuhausen am Rheinfall (CH)

(72) Inventors: Daniel J. Brandt, Hartland, WI (US); Allison M. Ahern, St Francis, WI (US); Kraig D. Ritmanich, Brookfield, WI (US); Marcus W. Mueller, Belgium, WI (US); Jennifer S. Cayemberg, Racine, WI (US); Christopher R. Amundson, Grafton, WI (US)

(73) Assignee: Tyco Fire & Security GmbH, Neuhausen am Rheinfall (CH)

(21) Appl. No.: 18/626,127

(22) Filed: Apr. 3, 2024

(51) Int. Cl. F24F 11/30; F24F 11/63

(52) U.S. Cl. CPC F24F 11/30; F24F 11/63

(57) ABSTRACT

A method of and systems for staging units in a building management system (BMS) determines a next unit of the plurality of units to add to or remove from contributing to the environmental operation in each controller of the number of units in the BMS. The systems or methods also can determine in each controller of the units if a respective unit for the controller is the next unit, and changing an operational mode of the respective unit if the respective unit is the next unit. The systems and methods can implement managerless twinning control.

### CROSS REFERENCE TO RELATED APPLICATIONS

The present application is related to U.S. application Ser. No. 17/743,640 filed May 13, 2022, U.S. Pat. No. 11,874,638, which is incorporated herein by reference in its entirety.

### BACKGROUND

The present disclosure relates generally to the management of building systems of a building. Some embodiments disclosed herein relate to the control of building systems including but not limited to control using managerless twinning operations.

A building can include various types of building subsystems and equipment, e.g., heating, ventilation, and/o air conditioning (HVAC) systems, security systems, fire response systems, etc. According to one example application, twinning control allows multiple units to function together on a common supply and return duct shaft.

### SUMMARY

One implementation of the present disclosure relates to a method of staging in a building management system (BMS). The BMS includes units configured to provide an environmental operation, and the units each include a controller. The method includes determining a next unit of the plurality of units to add to or remove from contributing to the environmental operation in each controller of the units, determining in each controller of the units if a respective unit for the controller is the next unit, and changing an operational mode of the respective unit if the respective unit is the next unit.

In some embodiments, the next unit is determined by determining a highest runtime or a lowest runtime. In some embodiments, the operational mode is on state or an off state. In some embodiments, each of the controllers includes an application. In some embodiments, the application is a managerless twinning application. In some embodiments, the managerless twinning application is configured to automatically add the respective unit to or remove the respective unit from contributing to the environmental operation in response to either changes in building load or loss of unit functionality. In some embodiments, each controller exchanges run time information for determining the next unit. In some embodiments, the units are part of a twinned roof top unit. In some embodiments, the method also includes exchanging shared parameters among each controller, and the shared parameters include duct pressure for a supply duct, duct pressure for a return duct, reliability data, setpoint data or a time stamp for a communication.

Another implementation of the present disclosure relates to twinned heating, ventilating, or air conditioning equipment. The twinned twinned heating, ventilating, or air conditioning equipment includes a first unit coupled to at least one shared duct, and a second unit coupled to the shared duct. The first unit includes a first circuit configured to perform managerless twinning control, and the second unit includes a second circuit configured to perform the managerless twinning control. The managerless twinning control adds the first unit or the second unit to or removes the first unit or the second unit from contributing to a heating, ventilating or air conditioning operation in response to either changes in building load or loss of communication.

In some embodiments, the first circuit and the second circuit are configured to automatically add the first unit or the second unit to or remove the first unit or the second unit from heating, ventilating or air conditioning operation in response to the loss of communication. In some embodiments, the first circuit and the second circuit are configured to exchange shared parameters among each controller. The shared parameters include duct pressure for a supply duct, duct pressure for a return duct, reliability data, setpoint data or a time stamp for a communication. In some embodiments, the first circuit and the second circuit are configured to select the first unit or the second unit to add or remove the unit from contributing to a heating, ventilating or air conditioning operation in response to changes in the building load and loss of unit functionality. In some embodiments, the first circuit and the second circuit are configured to select the first unit or the second unit add or remove it from contributing to a heating, ventilating or air conditioning operation in response run time. In some embodiments, the first circuit and the second circuit are configured to exchange run time data. In some embodiments, the first circuit and the second circuit are configured to exchange an identification of the a next unit to add it to or remove it from contributing to a heating, ventilating or air conditioning operation and determine if the identification is an identification of the first unit or second unit.

Another implementation of the present disclosure relates to one or more non-transitory computer-readable media storing program instructions that, when executed by one or more processors, cause the one or more processors to perform operations. The operations are for twinned heating, ventilating, or air conditioning equipment including a first unit and second unit sharing at least one duct. The operations include performing a managerless twinning control. The managerless twinning control adds the first unit or the second unit to or removes the first unit or the second unit from contributing to a heating, ventilating or air conditioning operation.

In some embodiments, the managerless twinning control automatically adds the first unit or the second unit to or removes the first unit or the second unit from contributing to the heating, ventilating or air conditioning operation in response to either changes in building load or loss of unit functionality. In some embodiments, the managerless twinning control selects the first unit or the second unit to add it to or remove it from contributing to a heating, ventilating or air conditioning operation in response run time. In some embodiments, the managerless twinning control adds or removes the first unit or the second unit to or from contributing to the heating, ventilating or air conditioning operation after a predetermined delay.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building including a building management system, according to some embodiments.

FIG. 2 is a general schematic block diagram of HVAC equipment in a twinning configuration for a building such as the building illustrated in FIG. 1, according to some embodiments.

FIG. 3 is a perspective view schematic drawings of an exemplary unit for the HVAC equipment in the twinning configuration illustrated in FIG. 2, according to some embodiments.

FIG. 4 is a block diagram of applications configured for twinning operations for the HVAC equipment illustrated in FIG. 2, according to some embodiments.

FIG. 5 is a flow diagram of twinning operations executed by applications illustrated in FIG. 4, according to some embodiments.

### DETAILED DESCRIPTION

According to some embodiments, managerless or independent twinning operations can be used for real-time monitoring, analysis, and optimization of building equipment in a distributed control fashion. Managerless twinning can enhance control strategies, improve efficiency, and facilitate predictive maintenance. Managerless twinning or independent twinning can use several operating parameters that are synchronized while others operating parameters are used independently. To synchronize parameters, each twinned unit in the group broadcasts its key parameter values so it can be used by the other units in the group. In some embodiments, the units are air handling units (AHUs) or roof top units (RTUs). Twinning can refer to an application where more than one rooftop unit, air handling unit., or other device is serving a shared supply and return duct in some embodiments. By operating units in unison, twinned systems can provide higher capacity and/or some system redundancy. Twinned systems are generally sized so all units are operating to meet the worst-case demand of the building.

Systems and methods advantageously avoid problems associated with conventional manager-subordinate algorithms that occur if the manager unit loses the ability to communicate with the subordinate units. In some embodiments, a managerless building control system includes equipment units that share a set of twinned values, run the control calculations independently, and collectively arrive at the same output. In some embodiments, the control systems and methods are configured to add or remove capacity to a building system by activating or deactivating selected equipment units. In some embodiments, systems and methods employ a managerless approach that has advantages over a manager-subordinate approach that relies upon Liebert's Teaming algorithm which employs a solely a hierarchical approach to assigning a new manager unit.

Referring generally to the FIGURES, automated sequencing operations for managerless twinning units are shown, according to various exemplary embodiments. In some embodiments, managerless twinning operations are configured to automatically add or remove capacity in response to either changes in the building load or loss of unit functionality (e.g., loss of communication, loss of fan, loss of heating or cooling capability, unit failure, etc.). In some embodiments, managerless twinning operations are configured to replace management subordinate control algorithms. In some embodiments, systems and methods select units with the lowest runtimes when adding capacity. If several units share the lowest runtime, the unit with the lowest numbered unique identifier is chosen in some embodiments. In some embodiments, systems and methods select units with the largest runtime when removing capacity. If several units share the largest runtime, the unit with the highest numbered unique identifier is chosen. In some embodiments, systems and methods select a standby unit using the same rules as a staging event if a unit is presently running and loses communication with the group for some pre-determined duration.

### Building and HVAC System

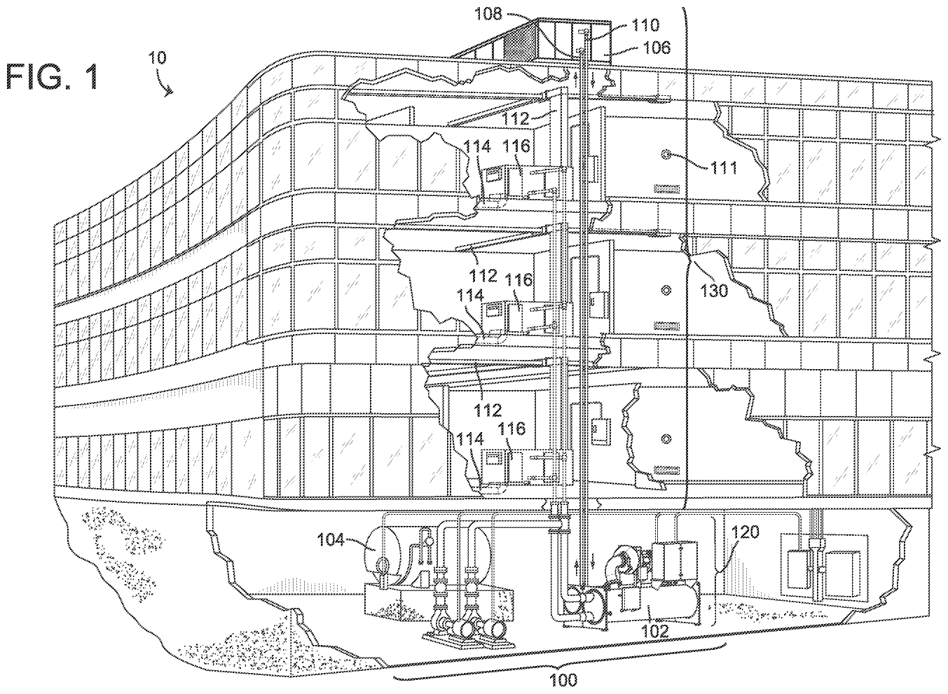

Referring now to FIG. 1, an exemplary building system (BMS) in which the systems and methods of some embodiments can be employed in a building 10. Building 10 is served by a HVAC system 100 which can be part of a BMS. HVAC system 100 can include a number of HVAC devices (e.g., heaters, chillers, air handling units, pumps, fans, thermal energy storage, twinned units, etc.) configured to provide heating, cooling, ventilation, or other services for building 10. For example, HVAC system 100 can include include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to RTU 106. In some embodiments, HVAC system 100 is not a chiller based system and does not use a chiller 102 or boiler 104 for heating or cooling. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to RTU 106 via piping 108. RTU 106 can place the working fluid in a heat exchange relationship with an airflow passing through RTU 106 (e.g., via one or more stages of cooling coils and/or heating coils). The airflow can be, for example, outside air, return air from within building 10, or a combination of both. RTU 106 can transfer heat between the airflow and the working fluid to provide heating or cooling for the airflow. For example, RTU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by RTU 106 (i.e., the supply airflow) to building 10 via air supply ducts 112 and can provide return air from building 10 to RTU 106 via air return ducts 114. In some embodiments, airside system 130 includes multiple local air handling units (AHUs) 116 positioned within building 10. The AHUs 116 may include various components similar to the RTU 106. In some embodiments, the airside system 130 includes variable air volume (VAV) units. For example, airside system 130 includes a separate VAV unit on each floor or zone of building 10. VAV units can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units or other flow control elements. RTU 106 and/or AHUs 116 can include various sensors (e.g., temperature sensors, pressure sensors, thermostats 111, etc.) configured to measure attributes of the supply airflow. RTU 106 and/or AHUs 116 can receive input from sensors located within RTU 106 and/or AHUs 116 and/or within the building zone and can adjust the flow rate, temperature, or other attributes of the supply airflow through RTU 106 and/or AHUs 116 to achieve setpoint conditions for the building zone.

RTU 106 can place the working fluid in a heat exchange relationship with an airflow passing through RTU 106 (e.g., via one or more stages of cooling coils and/or heating coils). The airflow can be, for example, outside air, return air from within building 10, or a combination of both. RTU 106 can transfer heat between the airflow and the working fluid to provide heating or cooling for the airflow. For example, RTU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by RTU 106 (i.e., the supply airflow) to building 10 via air supply ducts 112 and can provide return air from building 10 to RTU 106 via air return ducts 114. In some embodiments, airside system 130 includes multiple variable air volume (VAV) units or AHUs 116. For example, airside system 130 is shown to include a separate VAV unit or AHUs 116 on each floor or zone of building 10. VAV units or AHUs 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units or AHUs 116 or other flow control elements. RTU 106 can include various sensors (e.g., temperature sensors, pressure sensors, etc.) configured to measure attributes of the supply airflow. RTU 106 can receive input from sensors located within RTU 106 and/or within the building zone and can adjust the flow rate, temperature, or other attributes of the supply airflow through RTU 106 to achieve setpoint conditions for the building zone. AHU 116 and RTU 106 can be controlled using a managerless twinning control system or method in some embodiments. In some embodiments, RTU 106 and AHU 116 are variable refrigerant flow units or non-chiller based equipment.

### Managerless Twinning System and Method

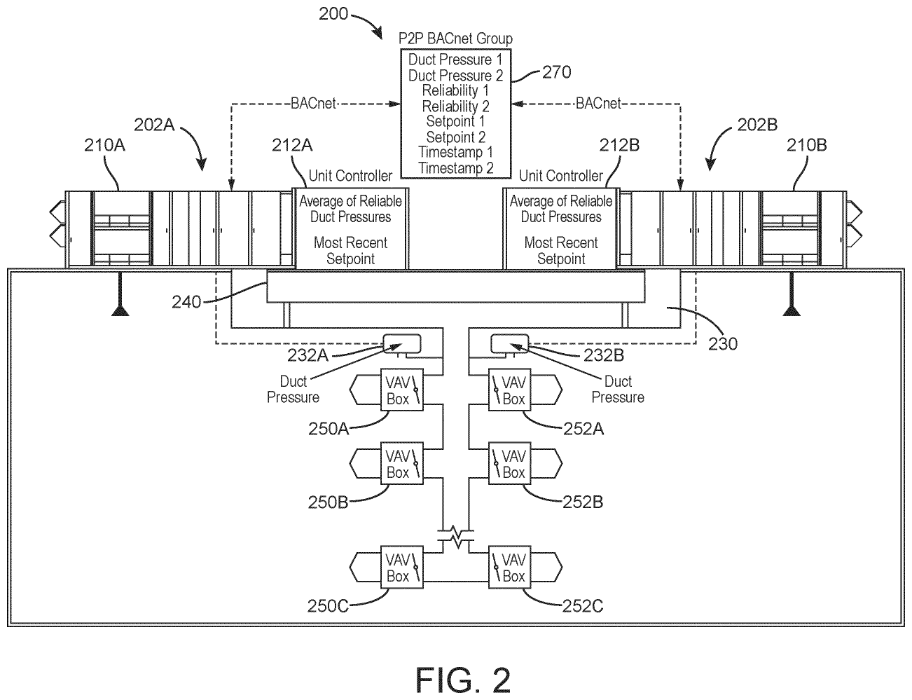

Referring now to FIG. 2, a managerless twinning roof top unit system 200 can be utilized with a building management system (BMS) (e.g., for building 10 (FIG. 1)). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. A BMS can be used to monitor and control the devices of HVAC system 100 (FIG. 1) including system 200 as well as other types of BMS devices (e.g., lighting equipment, security equipment, etc.). Although the managerless twinning operations are described with reference to system 200 embodied as a twinned roof top unit, the systems and methods are applicable to other BMS equipment including but not limited to air handling units (AHUs). System 200 can be similar to RTU 106 (FIG. 1) or be a stand-alone unit in some embodiments.

Managerless twinning roof top unit system 200 provides a system architecture that facilitates automatic equipment discovery and equipment staging. Equipment discovery can occur on multiple levels of system 200 across multiple different communications busses and across multiple different communications protocols. When new units are discovered, those units can begin sharing data for implementing staging operations. A new unit can be discovered after it has lost communication or otherwise malfunction and then begins operating normally in some embodiments. Staging can refer to operations for activation or deactivation of heating or cooling units based on demand, malfunction, or other criteria in some embodiments. Staging can improve energy efficiency, maintain comfort, and reduce maintenance in some embodiments. Units can be staged in both residential and commercial HVAC applications.

Managerless twinning roof top unit system 200 includes a unit 202A and a unit 202B in some embodiments. In some embodiments, system 200 includes three, four, five, six or more units similar to units 202A and 202B. Managerless twinning roof top unit system 200 includes separate groups of unit 202A and unit 202B in some embodiments.

Units 202A and 202B share a return duct 240 and a supply duct 230. Duct 230 is in communication with air handling units 250A-C and air handling units 252A-C. In some embodiments, units 202A and 202B are commercial roof top units. Unit 202A includes a controller 212A and a housing 210A, and unit 202B includes a controller 212B and a housing 210B. Housings 210A and 210B are in fluid communication with ducts 230 and 240 and can include fans, sensors, dampers, coils, compressors, pumps, pipes, ducts, valves, and other devices for providing heating, humidity, clean air, or cooling operations. System 200 can include any number of units 250A-C and 252A-C (e.g., air handling units connected to duct 230).

Controller 212A and 212B are in communication to exchange a peer to peer (P2P) controller data 270. Peer to peer (P2P) controller data 270 can include various setpoints, commands, sensed data, network data, etc. Controller data 270 is used for controlling units 202A and 202B through operation of controllers 212A and 212B including staging units 202A and 202 B in some embodiments. Controller data 270 can be exchanged between controllers 212A and 212B via any type of network or communication medium including but not limited to one or more of a wireless link (e.g., a WiFi network), a building automation and control network (BACnet), a direct connection, an ethernet network, or t other communication medium. Controller data 270 can be communicated in packets according to various protocols.

In some embodiments, controller data 270 includes but is not limited to duct pressure for duct 230, duct pressure for duct 240, reliability data for unit 202A, reliability data for unit 202B, a setpoint (e.g., pressure, temperature, air flow, etc.) for unit 202A, a setpoint (e.g., pressure, temperature, air flow, etc.) for unit 202B, a time stamp for a communication of unit 202A, or a time stamp for a communication of unit 202B. Controller data 270 can be communicated to controllers 212A and 212B via a BACnet bus or wirelessly in some embodiments. System 200 can include duct pressure sensors 232A and 232B in communication with respective controllers 212A and 212B in some embodiments. In some embodiments, setpoint, control parameters, output variables provided by units 202A and 202B (e.g., supply fan speeds), temperature measurements, feedback signals, configuration parameters used by the units 202A and 202B (e.g., operating mode, actuator stroke length, damper position, tuning parameters, etc.) can be exchanged and mapped to variables or parameters stored within the units 202A and 202B for communication of those variables or parameters to external systems or devices. Units 202A and 202B can store equipment models.

System 200 can include any number of units 202A and 202B and associated controllers 212A and 212B twinned together in groups larger than two or twinned in separate groups of two, or more in some embodiments. In some embodiments, units 202A and 202B are configured to be operated in unison to provide higher capacity and/or some system redundancy. System 200 is sized so all units 202A and 202B are operating meet the worst-case demand of building 10 (FIG. 1) in some embodiments. To operate a system 200 effectively and efficiently, operating parameters (sensor values and setpoints in controller data 270) are generally shared shared among all units connected to ducts 230 and 240 (e.g., shared ducts). In some embodiments, each of units 202A and 202B has knowledge of the system parameters and configurations and each of units 202A and 202B and can execute the same control algorithm independently. System 200 is more robust in operation with respect to individual communication errors or sensor failures and yet is less complex than with manager driven operations in some embodiments. Advantageously, if one of units 202A and 202B fails or is manually shut down, the remaining unit 202A or 202B continues to run without interruption. In some embodiments, several operating parameters are synchronized while other parameters operate independently. To synchronize parameters, each of units 202A and 202B unit in the group broadcasts its key parameter values so it can be used by the other units in the group.

Controllers 212A and 212B are able to adjust fan speed and additional unit operating parameters to provide better control and comfort. Various settings can be automatically synchronized by system 200 (e.g., using controller data 270). The synchronized parameters can include but are not limited to supply fan control, economizer suitability, occupancy, DCV, exhaust fan control, and smoke control. In some embodiments, supply fan control is synchronized to maintain discharge air (DA) static pressure between all units 202A and 202B serving the same duct 230. This requires all reliable DA static pressure values from units 202A and 202B to be averaged before passing to the proportional-integral-derivative (PID) control algorithm in some embodiments. In some embodiments, the static pressure setpoint is synchronized, and any change to one setpoint is shared with the units 202A and 202B. This allows the PID control algorithm in each of units 202A and 202B to calculate the same output value and run all the supply fans at the same speed.

During start-up of a previously shutdown rooftop unit of units 202A and 202B, the supply fan speed slowly ramps up until it matches the fan speeds of units 202A and 202B (RTUs) currently in operation. When the additional rooftop unit begins ramping, the static pressure increases, causing the other rooftop unit fan speeds to slow down to reach the setpoint in some embodiments. Once the rooftop unit fan speeds matches the existing rooftop unit's speed, the rooftop unit 202A or 202B releases into normal control. The economizer suitability can also be synchronized to allow all units 202A and 202B to use the outside air (OA) damper for free cooling when available in some embodiments. This also avoids a situation where one unit 202A is operating in economizer mode while another unit 202B operates in mechanical cooling mode. The occupancy for units 202A and 202B (e.g., twinned units) can also be synchronized to allow all units 202A and 202B to switch between occupied and unoccupied modes simultaneously. This includes the occupancy schedule and warm-up/cool down if enabled. The demand control vent (DCV) can be synchronized to allow the OA damper minimum position to be reset equally between the units 202A and 202B in some embodiments. This generally requires the indoor carbon dioxide values from the units to be shared and the maximum to be passed to the reset logic to ensure sufficient outside air is brought in for proper ventilation. The indoor carbon dioxide setpoint also synchronizes so the reset calculation is the same across all units 202A and 202B. In some embodiments, the exhaust fan system is synchronized to allow for proper building pressurization using averaged building static pressure values from each unit 202A and 202B to be averaged before passing to the PID control algorithm. The building static pressure setpoint also synchronizes, and any change to one setpoint is shared with the other rooftop units in some embodiments. The smoke control feature is synchronized to ensure all units 202A and 202 properly switch between the purge, pressurization, or depressurization modes. In some embodiments, the three smoke control binary inputs and their priorities on each unit are shared so that when any binary input is ON, all twinned units respond the same way.

In some embodiments, the temperature control, return fan systems, and safety shutdowns can operate individually on each unit 202A and 202B. The temperature setpoints synchronize to allow for similar operation between the units 202A and 202B. The temperature loops are not required to be as tightly coupled as the supply and exhaust fan systems. In some embodiments, two units 202A and 202 B are configured to share a common supply duct (duct 240). Each unit 202A and 202B has its own duct pressure sensor 232A and 232B (e.g., static pressure sensor) to allow units 202A and 202B to run independently when one or more units 202A and 202B are shut down for maintenance or communication is lost. The units 202A and 202B share duct static pressure present value, reliability, and setpoint. The units 202A and 202B use the averaged values of duct static pressure when the shared values are reliable. When a local sensor is unreliable on a given unit, that unit can use the shared value and continue to operate in some embodiments. In some embodiments, a change in duct static setpoint at one unit is propagated to the other units, and the user does not need to make setpoint changes at all units.

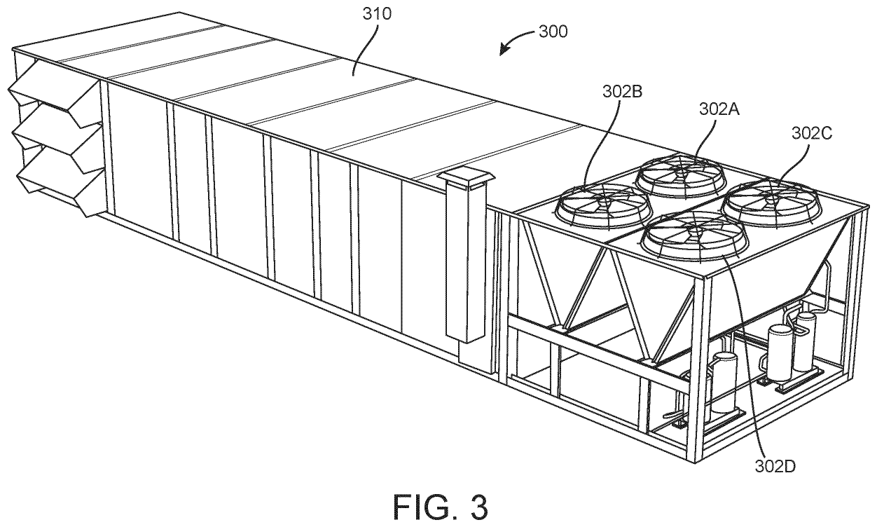

With reference to FIG. 3 a roof top unit 300 can be used as unit 202A and 202B. Unit 300 includes fan units 302A-D. A housing 310 can be in communication with supply and return ducts 230 and 240 (FIG. 2). Other mechanical and orientations of unit 300 are possible.

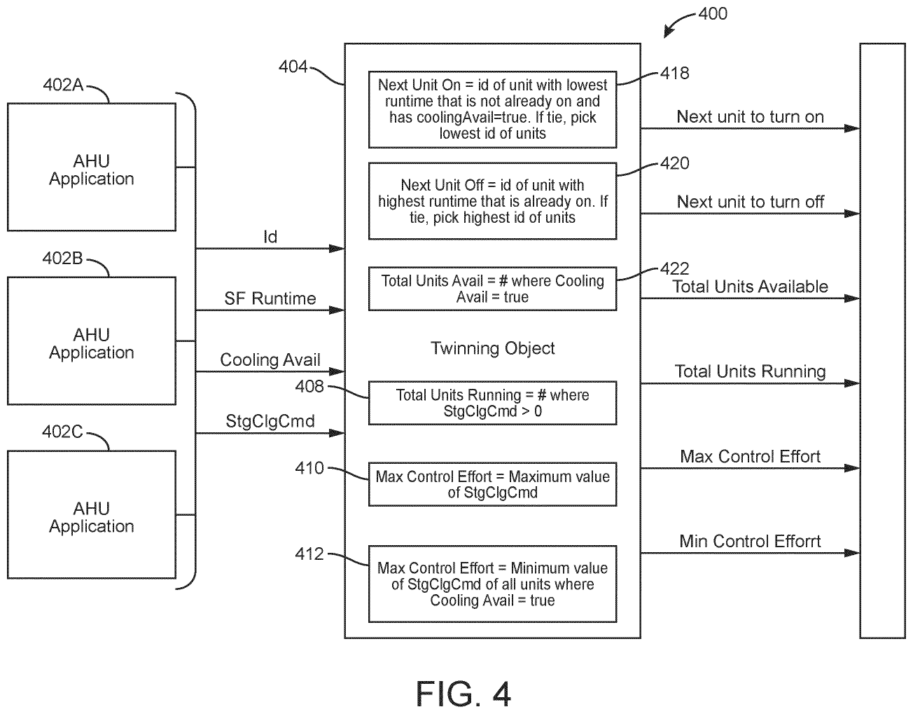

With reference to FIG. 4, a twinning control system 400 is configured to automatically add or remove capacity in response to either changes in the building load or loss of unit functionality. Loss of unit functionality can be a loss of communication, loss of fan, loss of heating or cooling capability, unit failure, etc. In some embodiments, a unit that is removed for loss of heating capability may be brought back online when a cooling mode is entered if that unit has cooling capability and vice versa. Twinning control system 400 is configured as a managerless twinning algorithm in some embodiments. Twinning control system 400 is for controllers 212A and 212 B (FIG. 2) and implemented in software executed on controllers 212A and 212B in some embodiments. Applications 402A-C are software applications, computer programs or a set of programs configured to cause a unit to operate as discussed herein in some embodiments.

Twinning control system 400 can be for a set of devices or units (e.g., units 202A and 202B or units 250A-C and 252A-C). Each member of a twin group of units can each be associated with one of applications 402A-C. Applications 402A-C provide control operations for their respective units and include common operative characteristics. The operations can include communication operations. Each member associated with applications 402A-C of the twin group broadcasts sensor data (e.g. controller data 270 (FIG. 2)) relevant to control the entire twin group of units. The data can include identification of units, runtime, cooling availability or capacity, a stage command, set points, etc. The data is then pre-processed individually by each application 402A-C of the units and used in control algorithms associated with the unit. Such pre-processing includes but is not limited to using the average sensor value of all units in the control loop as opposed to a local sensor value. In this manner, all units independently arrive at the same control outputs according to some embodiments. In the event a unit loses communication with the twin group, the unit will fall back to controlling with its local data in some embodiments.

Twinning control system 400 controls the staging of units through applications 402A-C according to operation of a twinning object 404 in some embodiments. In an operation 408 of twinning object 404, applications 402A-C control the staging of the units based upon the control effort of a cooling/heating loop depending upon mode. The twin group members all broadcast their control effort to the group in an operation 408. The control effort is broadcast when a unit has a stage command of more than 0. In some embodiments, the applications 402A-C can determine how many total units are running and at what effort or with what available capacity. Generally, all units should arrive at the same control effort, but in case the units do not, the maximum and minimum values are used for an upper value threshold and a lower value threshold for staging determinations in operations 410 and 412 in some embodiments. For example, if the lowest control effort is 50 percent for all of the units, then the lower value threshold is set to 50 percent, and if the highest control effort is 85 percent, the upper value threshold is set to 85 percent. The thresholds can change dynamically. The group adds or stages additional capacity (e.g., units) if the maximum group control effort exceeds the upper threshold for a predetermined duration. Similarly, the group removes or stages capacity (e.g., units) if the minimum group control effort falls below the lower threshold for a predetermined duration in some embodiments.

In some embodiments, the unit identification of the unit with the lowest runtime is determined at an operation 418. If there is a tie for the unit with the lowest runtime that is not already on, one of the units is chosen based upon a factor in some embodiments. The factor can be based on the lowest identification value, a user selected priority for ties, operating temperature of a unit, an alternating approach, or other criteria.

In some embodiments, the unit identification of the unit with the highest runtime is determined at an operation 420. If there is a tie for the unit with the highest runtime that is not already on, one of the units is chosen based upon a factor in some embodiments. The factor can be based on the highest identification value, a user selected priority for ties, an alternating approach, operating temperature of a unit, or other criteria.

In an operation 422, the number of units that have cooling availability or other capacity is determined. When control effort dictates a staging event should occur, the equipment to be added or removed is chosen based upon runtime and in the event of a tie based upon a unique identifier. When adding capacity, the unit with the lowest runtime is chosen from data determined in operation 418. If several units share the lowest runtime, the unit with the lowest numbered unique identifier is chosen in some embodiments. When removing capacity, the unit with the largest runtime is chosen from data determined in operation 420. If several units share the largest runtime, the unit with the highest numbered unique identifier is chosen in some embodiments. If a device is presently running and loses communication with the group for some pre-determined duration, if any equipment exists on standby then that unit is added using the same rules as a staging event. In some embodiments, the principles of staging and/or delaying the starting units as described in U.S. Pat. No. 11,874,638 can be used by applications 402A-C.

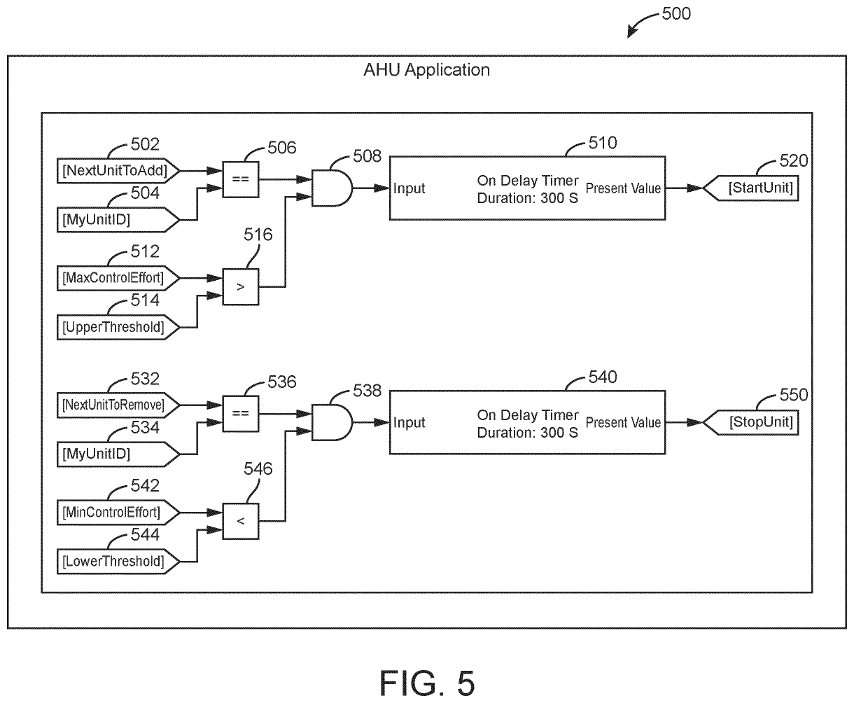

With reference to FIG. 5, a flow 500 is for operation by each of applications 402A-C (FIG. 4). Flow 500 is implemented in software in some embodiments. In some embodiments, flow 500 is part of applications 402A-B (FIG. 4) executed on respect controllers 212A-B (FIG. 2) in some embodiments. Flow 500 can be used to add or remove a unit. Flow 500 can be used for cooling operations as described below according to some embodiments. A flow similar to flow 500 can be used for heating, air cleaning, humidity, or other environmental control operations in some embodiments.

Applications 402A-C receive an identification 502 of the next unit to add in an add a unit operation (e.g., from operation 418). The identification 502 is compared in an operation 506 to a unit identification 504 for the particular application 402A-C. If the identifications 502 and 504 are the same, a logic signal is provided to an operation 508. Operation 508 can be implemented in a comparator.

Applications 402A-C receive a maximum control effort data 512 (e.g., from operation 410). The data 512 is compared in an operation 516 to an upper threshold data 514 for the particular application 402A-C. If the maximum control effort data 512 is greater than the upper threshold, a logic signal is provided to operation 508 by operation 516. Operation 516 can be implemented in a comparator, and operation 508 can be implemented by a logic devce.

Operation 508 provides a signal to operation 510 in response to the signals or data from operations 506 and 516. If the maximum control effort data 512 is greater than the upper threshold and if the identifications 502 and 504 are the same, operation 510 initiates a start unit operation 520. The start unit operation 520 can be performed after a delay (e.g., 100 to 500 milliseconds (300 milliseconds)) associated with operation 510 in some embodiments. Operation 520 can be a delay on operation and can be performed by a timer circuit with an interface for turning a unit on via one or more signals to its controller in some embodiments.

Applications 402A-C receive an identification 532 of the next unit to remove in a remove a unit operation (e.g., from operation 408). The identification 532 is compared in an operation 536 to a unit identification 534 for the particular application 402A-C. If the identifications 532 and 534 are the same, a logic signal is provided to operation 538. Operation 538 can be implemented in a comparator.

Applications 402A-C receive minimum control effort data 542 (e.g., from an operation 412). The data 542 is compared in an operation 546 to a lower threshold data 544 for the particular application 402A-C. If the minimum control effort data 542 is less than the lower threshold, a logic signal is provided to operation 546. Operation 546 can be implemented in a comparator.

Operation 538 provides a signal to operation 540 in response to the signals or data from operations 536 and 546. If the minimum control effort data 542 is less than the lower threshold and if the identifications 532 and 534 are the same, operation 440 initiates a stop unit operation 540. The stop unit operation 540 can be performed after a delay (e.g., 100 to 500 milliseconds (300 milliseconds)) in some embodiments. Operation 540 can be an off delay operation and can be performed by a timer circuit with an interface for turning a unit off via one or more signals to its controller in some embodiments.

In some embodiments, staging can be triggered according to various criteria. For example, the number of units (RTUs) can be chosen in response to a local forecast of needs, a remote forecast of needs, an occupancy schedule, sensed occupancy, an optimization model, or artificial intelligence. In some embodiments, the need for staging can be determined in cloud server by an HVAC building control software or a building management system. In some embodiments, the optimization model can be implemented in cloud server by an HVAC building control software or a building management system and can optimize for comfort and cost, comfort, and reduced maintenance, etc. In some embodiments, AI predicts changes in a data center at a head end of a network or in a cloud and indicates a need for staging based upon a predicted load. In some embodiments, an archive of data and real time data from the controllers can be communicated and stored in a central repository (e.g., external device or cloud system). The external device or cloud system can act as a virtual manager. The virtual manager can process data from the group, make staging decisions, and send desired command signals in some embodiments.

Controllers 212A-B (FIG. 2) can include memory, processors, circuitry, or devices configured to perform operations as described herein and run applications 402A-C (FIG. 4) and flow 500 (FIG. 5) using hardware, software, and combinations thereof. The processors can be a general purpose or specific purpose processor, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). Controllers 212A and 212 B are configured to determine the most reliable sensor data (average of reliable duct pressures) and most recent set points from controller data 270.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

Circuitry or circuit may refer to any electronic circuit or combination of circuits. To the extent that a device, circuit, processor or circuitry is described or recited in a claims as performing one or more operations or functions or as configured to perform to one or more operations or functions, the performance of the recited function(s) or operation(s) can be distributed across two or more devices, circuits, or processors without departing from the scope of the claims unless those functions or operations are explicitly recited as being performed on a specific single circuit or set of circuits, processor, or device (e.g., using the phrase “on a single circuit”, “on the set of circuits comprising” or “on a single device”).

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed:

1. A method of staging in a building management system comprising plurality of units configured to provide an environmental operation, the units each comprising a controller, method comprising:
determining a next unit of the plurality of units to add to or remove from contributing to the environmental operation in each controller of the plurality of units;
determining in each controller of the units if a respective unit for the controller is the next unit; and
changing an operational mode of the respective unit if the respective unit is the next unit.

2. The method of claim 1, wherein the next unit is determined by determining a highest runtime or a lowest runtime.

3. The method of claim 1, wherein the operational mode is on state or an off state.

4. The method of claim 1, wherein each of the controllers comprises an application.

5. The method of claim 4, wherein the application is a managerless twinning application.

6. The method of claim 5, wherein the managerless twinning application is configured to automatically add the respective unit to or remove the respective unit from contributing to the environmental operation in response to either changes in building load or loss of unit functionality.

7. The method of claim 1, wherein each controller exchanges run time information for determining the next unit.

8. The method of claim 1, wherein the units are part of a twinned roof top unit.

9. The method of claim 1, further comprising:
exchanging shared parameters among each controller, the shared parameters comprising duct pressure for a supply duct, duct pressure for a return duct, reliability data, setpoint data or a time stamp for a communication.

10. An apparatus, comprising
a first unit couple to at least one duct, wherein the first unit comprises a first circuit configured to perform managerless twinning control; and
a second unit coupled to the duct, wherein the second unit comprises a second circuit configured to perform the managerless twinning control, wherein the managerless twinning control adds the first unit or the second unit to or removes the first unit or the second unit from contributing to a heating, ventilating or air conditioning operation in response to either changes in building load or loss of unit functionality.

11. The apparatus of claim 10, wherein the apparatus comprises twinned heating, ventilating, or air conditioning equipment and wherein the first circuit and the second circuit are configured to automatically add the first unit or the second unit to or remove the first unit or the second unit from heating, ventilating or air conditioning operation in response to loss of unit functionality.

12. The apparatus of claim 10, the first circuit and the second circuit are configured to exchange shared parameters among each controller, the shared parameters comprising duct pressure for a supply duct, duct pressure for a return duct, reliability data, setpoint data or a time stamp for a communication.

13. The apparatus of claim 10, the first circuit and the second circuit are configured to select the first unit or the second unit to add to or remove from contributing to a heating, ventilating or air conditioning operation in response to changes in the building load and loss of unit functionality.

14. The apparatus of claim 10, the first circuit and the second circuit are configured to select the first unit or the second unit to add to or remove from contributing to a heating, ventilating or air conditioning operation in response run time.

15. The apparatus of claim 14, the first circuit and the second circuit are configured to exchange run time data.

16. The apparatus of claim 15, the first circuit and the second circuit are configured to exchange an identification of a next unit to add to or remove from contributing to the heating, ventilating or air conditioning operation and determine if the identification is an identification of the first unit or second unit.

17. One or more non-transitory computer-readable media storing program instructions that, when executed by one or more processors, cause the one or more processors to perform operations, the operations comprising:
performing a managerless twinning control, wherein the managerless twinning control adds a first unit or a second unit to or removes the first unit or the second unit from contributing to a heating, ventilating or air conditioning operation.

18. The one or more non-transitory computer-readable media of claim 17, wherein the operations are for twinned heating, ventilating, or air conditioning equipment comprising the first unit and the second unit sharing at least one duct, wherein the managerless twinning control automatically adds the first unit or the second unit to or removes the first unit or the second unit from contributing to the heating, ventilating or air conditioning operation in response to either changes in building load or loss of unit functionality.

19. The one or more non-transitory computer-readable media of claim 17, wherein the operations are for twinned heating, ventilating, or air conditioning equipment comprising the first unit and the second unit sharing at least one duct, wherein the managerless twinning control selects the first unit or the second unit to add to or remove from contributing to a heating, ventilating or air conditioning operation in response run time.

20. The one or more non-transitory computer-readable media of claim 17, wherein the operations are for twinned heating, ventilating, or air conditioning equipment comprising the first unit and the second unit sharing at least one duct, wherein the managerless twinning control adds or removes the first unit or the second unit to or from contributing to a heating, ventilating or air conditioning operation after a predetermined delay.
